(19) United States
(12) Patent Application Publication
(10) Pub. No.: US 2024/0053782 A1
(43) Pub. Date: Feb. 15, 2024

(54) SWITCHING VOLTAGE REGULATOR WITH PULSE GROUPING MITIGATION

(71) Applicant: Apple Inc., Cupertino, CA (US)

(72) Inventors: Daibashish GANGOPADHYAY, San Jose, CA (US); Terry J. GROOM, Rio Vista, TX (US)

(73) Assignee: Apple Inc., Cupertino, CA (US)

(21) Appl. No.: 17/887,279

(22) Filed: Aug. 12, 2022

(51) Int. Cl. G05F 1/575; H02M 3/158

(52) U.S. Cl. CPC G05F 1/575; H02M 3/158

(57) ABSTRACT

The present disclosure describes a system with a voltage regulator, a comparator circuit, and a control circuit. The voltage regulator includes an output node and is configured to generate a voltage at the output node. The comparator circuit is configured to compare the voltage at the output node to a reference voltage. The control circuit is configured to disable the voltage regulator after the voltage regulator has generated a charge cycle and for a period of time until the voltage at the output node is below the reference voltage.

### FIELD

This disclosure relates to a voltage regulator and, more particularly, to a voltage regulator with pulse grouping mitigation.

### BACKGROUND

Voltage regulators generate a stable output voltage within a range compatible with electronic circuits electrically connected to them. A type of voltage regulator is a DC-to-DC (DC-DC) converter, which converts a source of direct current (DC), such as a battery, from one voltage level to another. There are two types of DC-DC converters: linear and switched. A linear DC-DC converter uses a linear circuit element, such as a resistor, to regulate an output load. A switched DC-DC converter uses a switching circuit element, such as a switching transistor, to provide a pulsed voltage output to the output load. The pulsed voltage output can be smoothed using capacitors, inductors, and other circuit elements.

### SUMMARY

Embodiments of the present disclosure include a system having a voltage regulator, a comparator circuit, and a control circuit. The voltage regulator includes an output node and is configured to generate a voltage at the output node. The comparator circuit is configured to compare the voltage at the output node to a reference voltage. The control circuit is configured to disable the voltage regulator after the voltage regulator has generated a charge cycle and for a period of time until the voltage at the output node is below the reference voltage.

Embodiments of the present disclosure include a system having a voltage regulator, a frequency detection circuit, and an adjustable delay circuit. The voltage regulator includes an output node and is configured to generate a voltage at the output node. The frequency detection circuit is configured to monitor an activation frequency of the voltage regulator to generate the voltage at the output node. The adjustable delay circuit is configured to delay enabling the voltage regulator for a time period based on the activation frequency.

Embodiments of the present disclosure include a method for mitigating pulse grouping in a voltage regulator. The method includes generating a voltage at an output node of a voltage regulator; comparing the voltage at the output node to a reference voltage, where the reference voltage is lower than a maximum ripple voltage of the voltage regulator; and disabling the voltage regulator for a first period of time until the voltage at the output node is below the reference voltage, where the first period of time is longer than a second period of time associated with a transfer of charge from the voltage regulator to a load circuit electrically connected to the voltage regulator.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIG. 1 is an illustration of an electronic system, according to some embodiments.

FIG. 2 is an illustration of a block-level representation of a power management circuit, according to some embodiments.

FIG. 3 is an illustration of a circuit-level representation of a power management circuit, according to some embodiments.

FIG. 4 is an illustration of waveforms showing an operation of the power management circuit of FIG. 3, according to some embodiments.

FIG. 5 is an illustration of another circuit-level representation of a power management circuit, according to some embodiments.

FIG. 6 is an illustration of waveforms showing an operation of the power management circuit of FIG. 5, according to some embodiments.

FIG. 7 is an illustration of yet another circuit-level representation of a power management circuit, according to some embodiments.

FIG. 8 is an illustration of waveforms showing an operation of the power management circuit of FIG. 7, according to some embodiments.

FIG. 9 is an illustration of a method for mitigating pulse grouping in a voltage regulator, according to some embodiments.

FIG. 10 is an illustration of another method for mitigating pulse grouping in a voltage regulator, according to some embodiments.

FIG. 11 is an illustration of various exemplary systems or devices that can include the disclosed embodiments.

Illustrative embodiments will now be described with reference to the accompanying drawings. In the drawings, like reference numerals generally indicate identical, functionally similar, and/or structurally similar elements.

### DETAILED DESCRIPTION

The following disclosure provides many different embodiments, or examples, for implementing different features of the provided subject matter. Specific examples of components and arrangements are described below to simplify the present disclosure. These are merely examples and are not intended to be limiting. In addition, the present disclosure repeats reference numerals and/or letters in the various examples. This repetition is for the purpose of simplicity and clarity and, unless indicated otherwise, does not in itself dictate a relationship between the various embodiments and/or configurations discussed.

It is noted that references in the specification to “one embodiment,” “an embodiment,” “an example embodiment,” and “exemplary” indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure or characteristic is described in connection with an embodiment, it would be within the knowledge of one skilled in the art to effect such feature, structure or characteristic in connection with other embodiments whether or not explicitly described.

In some embodiments, the terms “about” and “substantially” can indicate a value of a given quantity that varies within 20% of the value (e.g., ±1%, ±2%, ±3%, ±4%, ±5%, ±10%, ±20% of the value). These values are merely examples and are not intended to be limiting. The terms “about” and “substantially” can refer to a percentage of the values as interpreted by those skilled in relevant art(s) in light of the teachings herein.

It is to be understood that the phraseology or terminology herein is for the purpose of description and not of limitation, such that the terminology or phraseology of the present specification is to be interpreted by those skilled in relevant art(s) in light of the teachings herein.

The following disclosure describes aspects of a voltage regulator, such as a switched DC-DC converter, with pulse grouping mitigation. Specifically, the present disclosure describes a voltage regulator configured to provide a voltage (e.g., a power supply voltage) at an output node and a pulse grouping control circuit configured to disable the voltage regulator after a charge cycle to transfer charge to a load circuit. After the charge cycle and for a period of time until the voltage at the output node is below a reference voltage, the pulse grouping control circuit can be configured to disable the voltage regulator: (1) if the voltage at the output node is above the reference voltage (e.g., a voltage higher than a regulated voltage of the voltage regulator); and/or (2) for a time period based on an activation frequency of the voltage regulator. By disabling the voltage regulator, the issuance of multiple inadvertent charge cycles by the voltage regulator (also referred to herein as “pulse grouping”) can be mitigated. Benefits of mitigating pulse grouping include the voltage regulator complying with voltage ripple specifications, operating with improved load versus frequency monotonicity, and avoiding the generation of an undesirable audible noise.

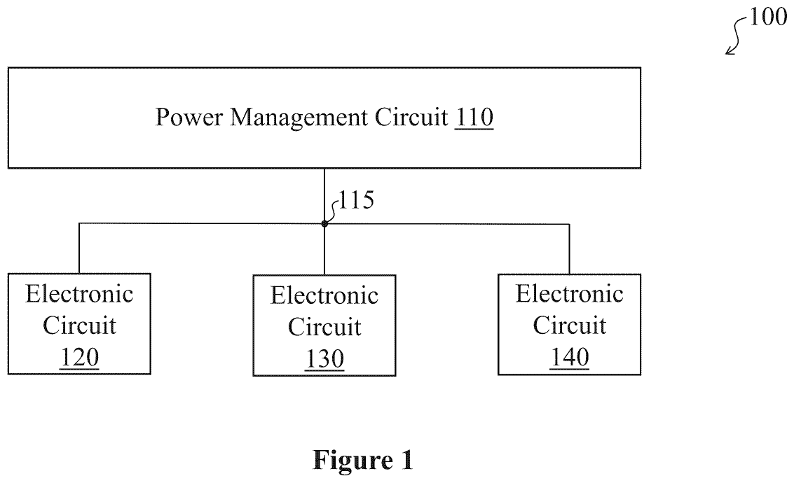

FIG. 1 is an illustration of an electronic system 100, according to some embodiments. Electronic system 100 includes a power management circuit 110 and electronic circuits 120, 130, and 140. Power management circuit 110 can convert a source of incoming power (e.g., a battery or other suitable power supply source) to desired voltage/current characteristics of electronic circuits 120, 130, and 140. In some embodiments, power management circuit 110 provides a supply voltage 115 (e.g., a power supply voltage 115) to electronic circuits 120, 130, and 140 and regulates supply voltage 115 as electronic circuits 120, 130, and 140 vary in voltage and/or current consumption (also referred to herein as a “load”). Supply voltage 115 can be at any suitable voltage level for electronic circuits 120, 130, and 140, such as at a power supply voltage (e.g., 1.0 V, 1.2 V, 1.8 V, 2.4 V, 3.3 V, and 5.0 V). Though electronic system 100 shows power management circuit 110 with a single supply voltage 115 electrically connected to electronic circuits 120, 130, and 140, electronic system 100 is not limited to such circuit architecture. For example, power management circuit 110 can provide different supply voltages to one or more of electronic circuits 120, 130, and 140. These other circuit architectures are within the scope of the present disclosure.

Electronic circuits 120, 130, and 140 can be any suitable type of electronic device, such as a processor circuit, a memory circuit, an input/output (I/O) circuit, a peripheral circuit, and combinations thereof. In some embodiments, the processor circuit can include a general-purpose processor to perform computational operations, such as a central processing unit. The processor circuit can also include other types of processing units, such as a graphics processing unit, an application-specific circuit, and a field-programmable gate array circuit. In some embodiments, the memory circuit can include any suitable type of memory, such as Dynamic Random Access Memory, Static Random Access Memory, Read-Only Memory, Electrically Programmable Read-Only Memory, non-volatile memory, and combinations thereof.

In some embodiments, the I/O circuit can coordinate data transfer between one of electronic circuits 120, 130, and 140 (e.g., a processor circuit) and a peripheral circuit. The I/O circuit can implement a version of Universal Serial Bus protocol or IEEE 1394 (Firewire®) protocol, according to some embodiments. Further, in some embodiments, the I/O circuit can perform data processing to implement networking standards, such as an Ethernet (IEEE 802.3) networking standard. Examples of the peripheral circuit can include storage devices (e.g., magnetic or optical media-based storage devices, including hard drives, tape drives, CD drives, DVD drives, and any suitable storage device), audio processing systems, and any suitable type of peripheral circuit, according to some embodiments.

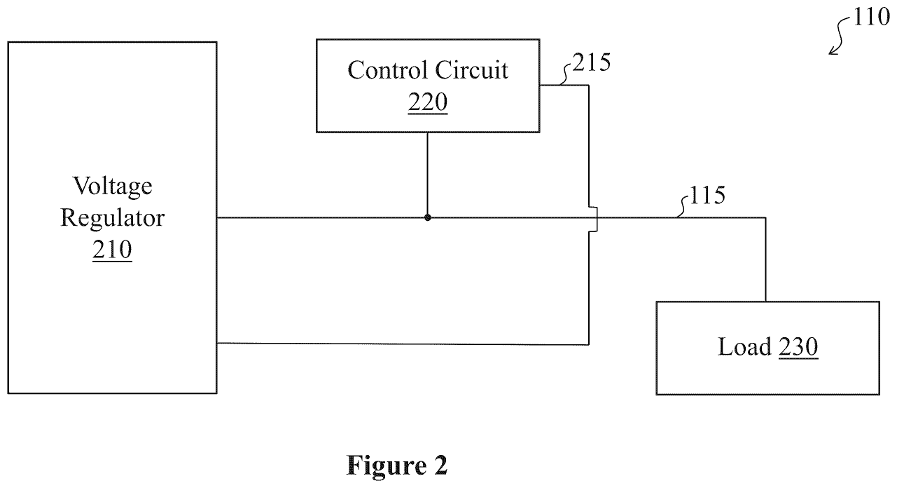

FIG. 2 is an illustration of a block-level representation of a power management circuit 110, according to some embodiments. Power management circuit 110 includes a voltage regulator 210, a pulse grouping control circuit 220, and a load circuit 230, according to some embodiments. Load circuit 230 represents one or more of electronic circuits 120, 130, and 140 of FIG. 1. As described above, electronic circuits 120, 130, and 140 can vary in load. In some embodiments, voltage regulator 210 can electrically connect to one or more of electronic circuits 120, 130, and 140 at different times—which can depend on, for example, operation(s) being performed by electronic system 100 of FIG. 1.

Referring to FIG. 2, voltage regulator 210 provides a supply voltage 115 at an output node. In some embodiments, voltage regulator 210 can be a switched DC-DC voltage converter, such as a step-up voltage converter (e.g., a boost voltage converter), a step-down voltage converter (e.g., a buck voltage converter), or a step down/up voltage converter (e.g., a buck-boost voltage converter). The switched DC-DC converter can employ a pulse frequency modulation (PFM) mode of operation, where a switching frequency of the switched DC-DC voltage converter can change as a function of a current consumed by load circuit 230 (e.g., positive or negative load current). The PFM mode of operation can be asynchronous, in which switched DC-DC converter pulses are generated when supply voltage 115 falls below a desired output voltage of the switched DC-DC converter (e.g., a regulated voltage of the switched DC-DC converter). As a result, switching losses in the switched DC-DC converter can be reduced, thus improving the converter's power conversion efficiency for positive and negative load currents (e.g., bi-polar load current).

In some embodiments, supply voltage 115 can be a power supply voltage to load circuit 230. The voltage level of supply voltage 115 can be at any suitable voltage level for load circuit 230, such as 1.0 V, 1.2 V, 1.8 V, 2.4 V, 3.3 V, and 5.0 V. Due to the switching characteristics of the switched DC-DC voltage converter and parasitic effects of load circuit 230, a voltage ripple can appear on supply voltage 115, in which supply voltage 115 can rise to a maximum voltage level and fall to a minimum voltage level. The parasitic effects can be associated with capacitive characteristics associated with load circuit 230, such as equivalent series resistance (ESR) and equivalent series inductance (ESL) impedance characteristics of load circuit 230. For example, the maximum and minimum voltage levels of supply voltage 115 can be ±5%, ±10%, ±15%, and ±20%— or any other suitable voltage percentage—of the desired output voltage of the switched DC-DC converter.

The voltage ripple on supply voltage 115 (e.g., due to the parasitic effects of load circuit 230) can cause supply voltage 115 to fall below the regulated voltage of voltage regulator 210 before supply voltage 115 discharges below the regulated voltage. As a result, an inadvertent charge cycle can be issued by voltage regulator 210 in this undesirable pulse grouping scenario. In addition to the parasitic effects of load circuit 230, pulse grouping by voltage regulator 210 can be caused by other factors, such as internal noise in electronic system 100, a comparator offset variation in voltage regulator 210, and combinations thereof.

Referring to FIG. 2, pulse grouping control circuit 220 can be configured to disable voltage regulator 210, via a voltage regulator disable signal 215, to mitigate pulse grouping. In some embodiments, after a charge cycle issued by voltage regulator 210 and before a voltage at the output node of voltage regulator 210 discharges below the regulated voltage of voltage regulator 210, pulse grouping control circuit 220 can be configured to disable voltage regulator 210: (1) if the voltage at the output node is above the reference voltage (e.g., a voltage higher than a regulated voltage of voltage regulator 210); and/or (2) for a time period based on an activation frequency of voltage regulator 210. By mitigating pulse grouping, voltage regulator 210 can comply with voltage ripple specifications, operate with improved load versus frequency monotonicity, and avoid generation of an undesirable audible noise.

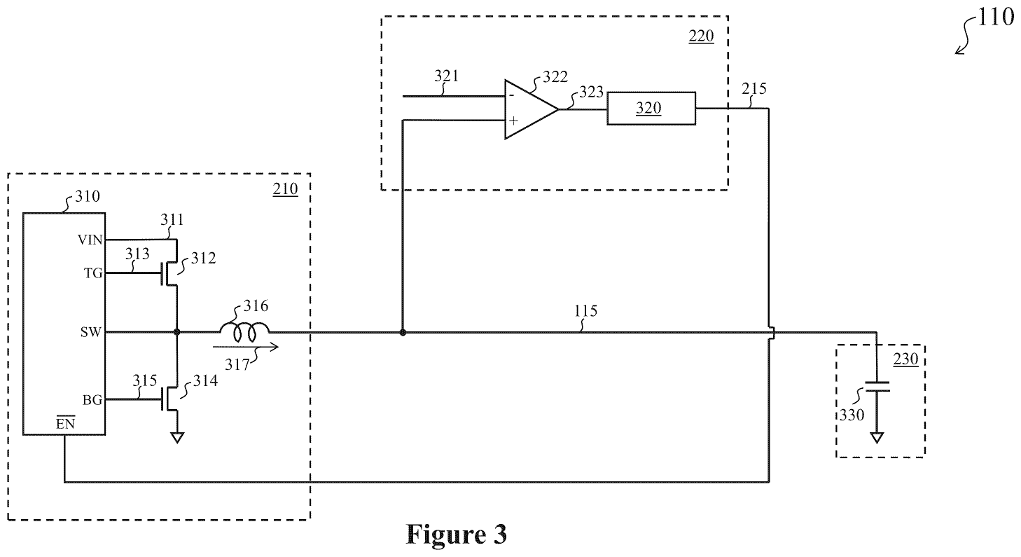

FIG. 3 is an illustration of a circuit-level representation of power management circuit 110, according to some embodiments. This circuit-level representation includes voltage regulator 210, an embodiment of pulse grouping control circuit 220, and load circuit 230. Voltage regulator 210 is configured to provide a voltage at its output node (e.g., at supply voltage 115) and can have a step-down voltage converter architecture (e.g., a buck voltage converter architecture), according to some embodiments. Voltage regulator 210 includes a switch controller 310, a first switching transistor 312, a second switching transistor 314, and an inductor 316.

Switch controller 310 provides pulses to first switching transistor 312 and second switching transistor 314 according to a PFM mode of operation, according to some embodiments. For example, in the PFM mode of operation, switch controller 310 can provide pulses to turn on and off first switching transistor 312 and second switching transistor 314 at variable times for a charge cycle—via a signal line 313 and a signal line 315 electrically connected to a gate terminal of first switching transistor 312 and a gate terminal of second switching transistor 314, respectively-based on the load required by load circuit 230. As the load requirement increases, switch controller 310 can turn on and off first switching transistor 312 and second switching transistor 314 (also referred to herein as “switching frequency”) at an increased frequency for a charge cycle to pass a voltage from a power supply source (e.g., a battery or other suitable power supply source) via a signal line 311 to an inductor 316, which in turn provides a current 317 to load circuit 230. Conversely, as the load requirement decreases, switch controller 310 decreases the switching frequency of first switching transistor 312 and second switching transistor 314 for a charge cycle.

In some embodiments, first switching transistor 312 and second switching transistor 314 can be n-type transistors, p-type transistors, or a combination thereof. In some embodiments, first switching transistor 312 and second switching transistor 314 can be metal-oxide-semiconductor (MOS) transistors, such metal-oxide semiconductor field-effect transistors (MOSFETs), fin field-effect transistors (FinFETs), gate-all-around field-effect transistors (GAAFETs), gallium nitride field effect transistors (GaNFETs), or any other suitable type of transistors.

Switch controller 310 can include a comparator circuit (not shown in FIG. 3) to assist in regulating a desired output voltage of voltage regulator 210 (e.g., a regulated voltage of voltage regulator 210) at supply voltage 115. In some embodiments, the comparator circuit can compare the voltage level of supply voltage 115 (e.g., in which switch controller 310 can receive a feedback signal electrically connected to supply voltage 115)—or a voltage level representative of supply voltage 115—to a voltage regulator reference voltage. If the voltage at supply voltage 115 (or voltage level representative of supply voltage 115) is below the voltage regulator reference voltage—e.g., load circuit 230 draws current away from supply voltage 115—voltage regulator 210 can be enabled and switch controller 310 can adjust the switching frequency to turn on and off first switching transistor 312 and second switching transistor 314 for a charge cycle to increase the voltage level of supply voltage 115 to or above the desired output voltage of voltage regulator 210, according to some embodiments. After supply voltage 115 reaches the desired output voltage of voltage regulator 210, voltage regulator 210 can be disabled (or set in a high-Z state)—e.g., no pulses are received by first switching transistor 312 and second switching transistor 314—until supply voltage 115 falls below the desired output voltage of voltage regulator 210. When voltage regulator 210 is disabled, the gate terminal of first transistor 312 (signal line 313) can be electrically connected to an output terminal SW of controller 310 (which is at ground or 0 V when voltage regulator 210 is disabled) and the gate terminal of second transistor 314 (signal line 315) can be electrically connected to ground. When disabled, voltage regulator 210 is in a high-Z state until supply voltage 115 falls below the desired output voltage of voltage regulator 210. And, when this supply voltage 115 condition occurs, voltage regulator 210 is enabled and provides pulses to first switching transistor 312 and second switching transistor 314 for a charge cycle to raise the voltage level of supply voltage 115.

Referring to FIG. 3, pulse grouping control circuit 220 includes a voltage regulator control circuit 320 and a comparator circuit 322, according to some embodiments. Comparator circuit 322 is configured to compare a voltage at the output node of voltage regulator 210 (e.g., supply voltage 115) to a reference voltage 321. In some embodiments, reference voltage 321 (e.g., about 1.2 to about 1.25 V) can be higher than the regulated voltage of voltage regulator 210 (e.g., about 1.0 to about 1.15 V) but lower than a maximum ripple voltage of supply voltage 115 (e.g., about 1.3 to about 1.5 V) when voltage regulator 210 is enabled. If the voltage at the output node of voltage regulator 210 is below reference voltage 321, a comparator circuit output 323 is at logic low (e.g., ground or 0 V). Conversely, if the voltage at the output node of voltage regulator 210 is above reference voltage 321, comparator circuit output 323 is at logic high (e.g., a power supply voltage).

If comparator circuit output 323 is at logic high, voltage regulator control circuit 320 is configured to disable voltage regulator 210 after a charge cycle of voltage regulator 210 and for a period of time until the voltage at the output node of voltage regulator 210 is below reference voltage 321 (e.g., for a period of time until comparator circuit output 323 transitions from logic high to logic low), according to some embodiments. In some embodiments, voltage regulator control circuit 320 is configured to monitor the charge cycle of voltage regulator 210 for a predetermined charge cycle time and to prevent voltage regulator 210—via voltage regulator disable signal 215—from generating another charge cycle during the predetermined charge cycle time. After the predetermined charge cycle time, if the voltage at the output node of voltage regulator 210 is above reference voltage 321, voltage regulator control circuit 320 is configured to delay the enablement of voltage regulator 210 until the voltage at the output node is below reference voltage 321. In some embodiments, the predetermined charge cycle time can be based on a time period associated with a full transfer of charge from voltage regulator 210 to load circuit 230. The predetermined charge cycle time can be longer than the time period associated with the full transfer of charge to ensure that the charge transfer operation is completed, according to some embodiments.

For example, if the voltage at the output node discharges below the regulated voltage of voltage regulator 210, voltage regulator 210 generates a charge cycle (e.g., via switch controller 310 to send pulses to first switching transistor 312 and second switching transistor 314) during the predetermined charge cycle time. After the predetermined charge cycle time, if voltage regulator 210 generates an inadvertent charge cycle due to an undesirable pulse grouping scenario (e.g., due to the parasitic effects of load circuit 230, internal noise in electronic system 100, a comparator offset variation in voltage regulator 210, and combinations thereof), voltage regulator control circuit 320 disables voltage regulator 210—via voltage regulator disable signal 215—for a period of time until the voltage at the output node is below reference voltage 321. In some embodiments, this period of time can be longer than the predetermined charge cycle time. To disable voltage regulator 210, voltage regulator control circuit 320 can disable switch controller 310—via voltage regulator disable signal 215—by preventing pulses to be received by first switching transistor 312 and second switching transistor 314, according to some embodiments.

Referring to FIG. 3, load circuit 230 is represented by a capacitor 330. Capacitor 330 can represent the capacitance of one or more of electronic circuits 120, 130, and 140 electrically connected to voltage regulator 210.

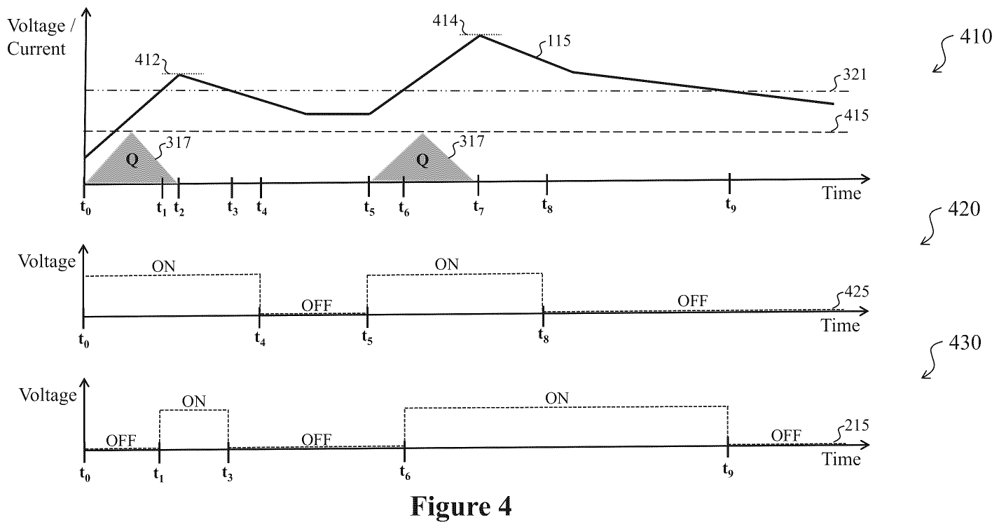

FIG. 4 is an illustration of waveforms 410, 420, and 430 showing an operation of the power management circuit of FIG. 3, according to some embodiments. Waveform 410 shows an example behavior of supply voltage 115 over time and an example behavior of current 317 (e.g., current flowing through inductor 316 of voltage regulator 210) over time. Waveform 420 shows an example behavior of a predetermined charge cycle time 425 over time. Waveform 430 shows an example behavior of voltage regulator disable signal 215 over time. The curvatures in waveforms 410, 420, and 430 are exemplary and for illustration purposes; these waveforms may include different curvatures.

Referring to waveform 410, during time period time to t₀ time t₄, supply voltage 115 falls below a regulated voltage 415 of voltage regulator 210—e.g., due to a current drawn by load circuit 230. Because supply voltage 115 is below regulated voltage 415, voltage regulator 210 is enabled, causing switch controller 310 to adjust the switching frequency of first switching transistor 312 and second switching transistor 314 for a charge cycle to raise supply voltage 115. During time period time to t₀ time t₂, voltage regulator 210 fully transfers current 317 (or charge Q) to load circuit 230, thus raising supply voltage 115 above regulated voltage 415. Once supply voltage 115 reaches regulated voltage 415, voltage regulator 210 is disabled (or set in a high-Z state)—e.g., no pulses are received by first switching transistor 312 and second switching transistor 314. As described above, in some embodiments, reference voltage 321 (e.g., about 1.2 to about 1.25 V) can be higher than regulated voltage 415 (e.g., about 1.0 to about 1.15 V) but lower than a maximum ripple voltage 412 (e.g., about 1.3 to about 1.5 V) when voltage regulator 210 is enabled.

Referring to waveform 420, during time period time to t₀ time t₄, predetermined charge cycle time 425 is at logic high (e.g., ON). Predetermined charge cycle time 425 can be at logic high for a period of time from when voltage regulator 210 is enabled (to increase supply voltage 115 above regulated voltage 415) to at least when current 317 (or charge Q) is fully transferred to load circuit 230. In some embodiments, as shown in waveform 420, predetermined charge cycle time 425 can be at logic high for a predetermined time period (e.g., time period time to t₀ time t₄) that is longer than a time period associated with the full transfer of charge (e.g., time period time to t₀ time t₂) to ensure that the charge transfer operation is completed. While predetermined charge cycle time 425 is at logic high, voltage regulator control circuit 320 is configured to enable voltage regulator 210 to generate only a single charge cycle during this time period.

Referring to waveform 430, during time period time t₁ to time t₃, voltage regulator disable signal 215 is at logic high (e.g., ON). During time period time t₁ to time t₃, supply voltage 115 is above reference voltage 321. While voltage regulator disable signal 215 is at logic high, voltage regulator control circuit 320 is configured to disable voltage regulator 210—via voltage regulator disable signal 215—by preventing pulses to be received by first switching transistor 312 and second switching transistor 314, according to some embodiments.

Referring to waveform 410, at time t₄, voltage regulator 210 has completed a charge cycle, supply voltage 115 is below reference voltage 321, and predetermined charge cycle time 425 and voltage regulator disable signal 215 are at logic low (e.g., OFF). During time period time t₄ to time t₅, while supply voltage 115 is between regulated voltage 415 and reference voltage 321, an undesirable pulse grouping scenario can occur (e.g., due to the parasitic effects of load circuit 230, internal noise in electronic system 100, a comparator offset variation in voltage regulator 210, and combinations thereof) and cause voltage generator 210 to generate an inadvertent charge cycle during time period time t₅ to time t₇. Due to the inadvertent charge cycle, supply voltage 115 rises to a maximum ripple voltage 414 higher than maximum ripple voltage 412.

Referring to waveform 420, during time period time t₅ to time t₈, predetermined charge cycle time 425 is at logic high (e.g., ON) for a predetermined time period. This predetermined time period is similar to that of predetermined charge cycle 425 during time period time to and time t₄, according to some embodiments.

Referring to waveform 430, during time period time t₆ to time t₉, voltage regulator disable signal 215 is at logic high (e.g., ON) while supply voltage 115 is above reference voltage 321—thus disabling voltage regulator 210. Compared to voltage regulator disable signal 215 during time period time t₁ to time t₃, voltage regulator disable signal 215 during time period time t₆ to time t₉ can be at logic high for a longer amount of time because of the discharge time of supply voltage 115. As described above, due to the inadvertent charge cycle, maximum ripple voltage 414 can be higher than maximum ripple voltage 412. In turn, the higher maximum ripple voltage 414 can result in a longer time for supply voltage 115 to discharge to reference voltage 321 as compared to maximum ripple voltage 412—thus resulting in a longer time period that voltage regulator disable signal 215 is at logic high.

A benefit of varying the time period of voltage regulator disable signal 215 based on the voltage level of supply voltage 115, among others, is that an extended amount of time is provided to supply voltage 115 to settle—thus decreasing the likelihood of a pulse grouping scenario. Further, a benefit of disabling voltage regulator 210 when supply voltage 115 rises above reference voltage 321, among others, is that a maximum ripple voltage of supply voltage 115 can be capped and not increase higher than this capped voltage value due to an inadvertent charge cycle. Without the varying time period of voltage regulator disable signal 215, an increased number of inadvertent charge cycles can be generated by voltage regulator 210—e.g., pulse grouping—thus increasing the likelihood of non-compliance with voltage ripple specifications, worsening load versus frequency monotonicity, and generating an undesirable audible noise.

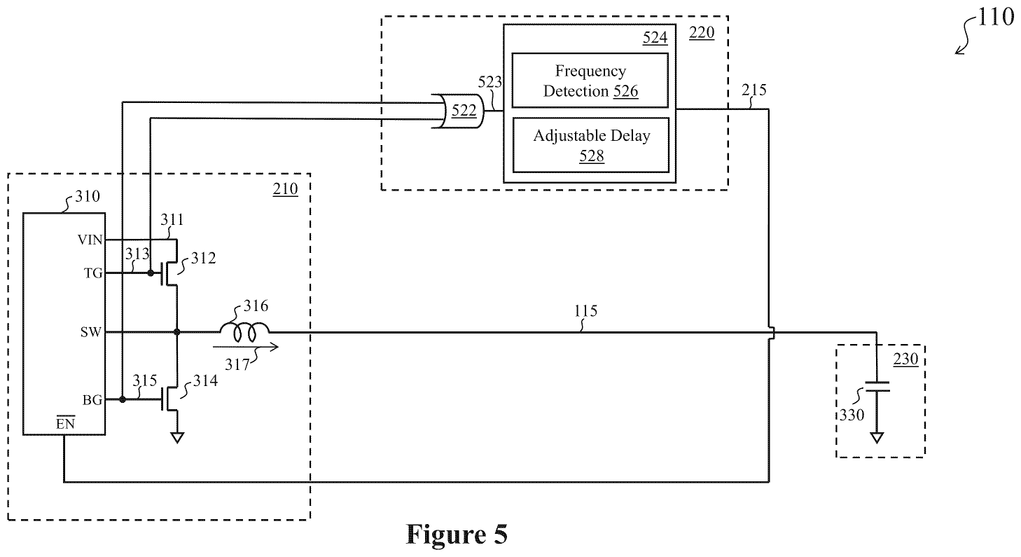

FIG. 5 is an illustration of another circuit-level representation of power management circuit 110, according to some embodiments. This circuit-level representation includes voltage regulator 210, another embodiment of pulse grouping control circuit 220, and load circuit 230. The descriptions of voltage regulator 210 and load circuit 230 are similar to the descriptions above.

Pulse grouping control circuit 220 includes a logic OR circuit 522 and a voltage regulator control circuit 524. Inputs of logic OR circuit 522 are electrically connected to the gate terminals of first switching transistor 312 and second switching transistor 314 via signal line 313 and signal line 315, respectively. When voltage regulator 210 is disabled (or set in a high-Z state)—e.g., no pulses are received by first switching transistor 312 and second switching transistor 314—the gate terminals of first switching transistor 312 and second switching transistor 314 can each be at logic low. Logic OR circuit 522 receives the logic low inputs and outputs logic low at a logic OR output 523. Conversely, when voltage regulator 210 is enabled— e.g., pulses are received by first switching transistor 312 and second switching transistor 314— either of the gate terminals of first switching transistor 312 and second switching transistor 314 is at logic high. Logic OR circuit 522 receives the logic high input and outputs logic high at logic OR output 523.

Voltage regulator control circuit 524 includes a frequency detection circuit 526 and an adjustable delay circuit 528, according to some embodiments. In some embodiments, voltage regulator control circuit 524 is configured to monitor a charge cycle of voltage regulator 210 for a predetermined charge cycle time that can be extended by adjustable delay circuit 528 and to prevent voltage regulator 210—via voltage regulator disable signal 215—from generating another charge cycle during the predetermined charge cycle time (and the extended delay time, if any). In some embodiments, the predetermined charge cycle time can be based on a time period associated with a full transfer of charge from voltage regulator 210 to load circuit 230. The predetermined charge cycle time can be longer than the time period associated with the full transfer of charge to ensure that the charge transfer operation is completed, according to some embodiments.

In some embodiments, adjustable delay circuit 528 can extend the predetermined charge cycle time—thus delaying the enablement of voltage regulator 210—based on an activation frequency of voltage regulator 210 measured by frequency detection circuit 526. Adjustable delay circuit 528 can include multiple delay elements (e.g., multiple strings of inverter circuits arranged to provide multiple delay times), where each delay element is associated with an activation frequency range of voltage regulator 210. Based on the activation frequency measured by frequency detection circuit 526, adjustable delay circuit 528 can select a delay element associated with the measured activation frequency. In some embodiments, adjustable delay circuit 528 is configured to generate the time period that delays enablement of voltage regulator 210 by adding the delay associated with the delay element to the predetermined charge cycle time.

In some embodiments, over a predetermined period of time, frequency detection circuit 526 can monitor a number of times the output of logic OR circuit 522 transitions from logic low to logic high (and/or vice versa)—which is indicative of a number pulses received by first switching transistor 312 and second switching transistor 314 and a number of charge cycles generated by voltage regulator 210 over the predetermined period of time. This number of charge cycles over the predetermined period of time is also referred to herein as an “activation frequency” of voltage regulator 210. Other methods can be used to measure the activation frequency of voltage regulator 210. For a higher activation frequency of voltage regulator 210 (e.g., voltage regulator 210 generates a higher number of charge cycles over the predetermined period of time), adjustable delay circuit 528 can provide a shorter delay to extend the predetermined charge cycle compared to an adjustable delay associated with a lower activation frequency of voltage regulator 210 (e.g., voltage regulator 210 generates a lower number of charge cycles over the predetermined period of time). Conversely, for a lower activation frequency, adjustable delay circuit 528 can provide a longer delay to extend the predetermined charge cycle compared to an adjustable delay associated with a higher activation frequency of voltage regulator 210.

For example, if the output node of voltage regulator 210 discharges below the regulated voltage of voltage regulator 210, voltage regulator 210 generates a charge cycle (e.g., via switch controller 310 to send pulses to first switching transistor 312 and second switching transistor 314) during the predetermined charge cycle time. Voltage regulator control circuit 524 can extend the predetermined charge cycle time by adding an adjustable delay from adjustable delay circuit 528—based on the activation frequency of voltage regulator 210—to allow additional time for the output node to settle. In some embodiments, when the activation frequency of voltage regulator 210 increases, adjustable delay circuit 528 is configured to decrease the delay added to the predetermined charge cycle time—thus decreasing the time period associated with the delay enabling voltage regulator 210. Conversely, in some embodiments, when the activation frequency of voltage regulator 210 decreases, adjustable delay circuit 528 is configured to increase the delay added to the predetermined charge cycle time thus increasing the time period associated with the delay enabling voltage regulator 210. During the predetermined charge cycle time and the extended adjustable delay, voltage regulator control circuit 524 prevents voltage regulator 210—via voltage regulator disable signal 215—from generating another charge cycle.

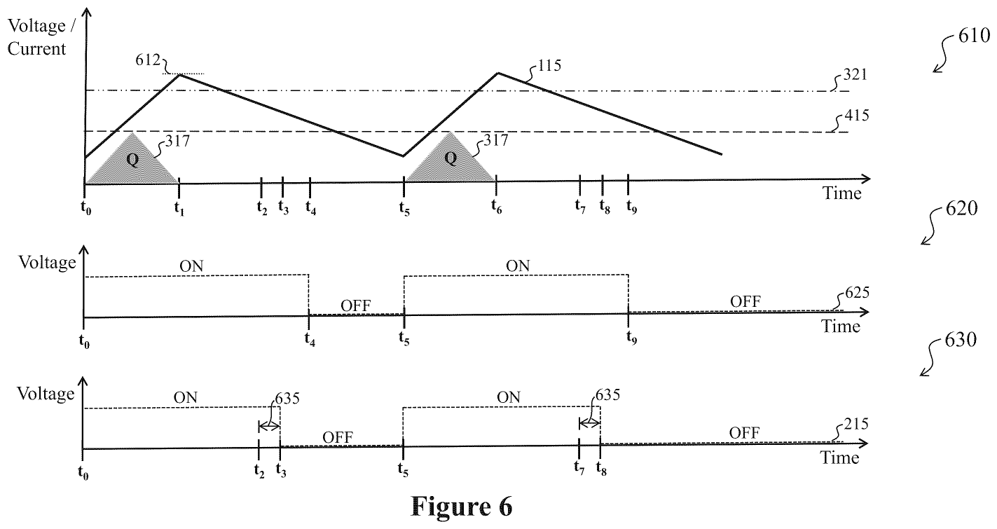

FIG. 6 is an illustration of waveforms 610, 620, and 630 showing an operation of the power management circuit of FIG. 5, according to some embodiments. Waveform 610 shows an example behavior of supply voltage 115 over time and an example behavior of current 317 (e.g., current flowing through inductor 316 of voltage regulator 210) over time. Waveform 620 shows an example behavior of a predetermined period of time 625 over which a number of charge cycles is generated by voltage regulator 210. Waveform 630 shows an example behavior of an example of voltage regulator disable signal 215 over time. The curvatures in waveforms 610, 620, and 630 are exemplary and for illustration purposes; these waveforms may include different curvatures.

Referring to waveform 610, during time period time to t₀ time t₄, supply voltage 115 falls below regulated voltage 415 of voltage regulator 210—e.g., due to a current drawn by load circuit 230. Because supply voltage 115 is below regulated voltage 415, voltage regulator 210 is enabled, causing switch controller 310 to adjust the switching frequency of first switching transistor 312 and second switching transistor 314 to raise supply voltage 115. During time period time to t₀ time t₁, voltage regulator 210 fully transfers current 317 (or charge Q) to load circuit 230, thus raising supply voltage 115 above regulated voltage 415. Once supply voltage 115 reaches regulated voltage 415, voltage regulator 210 is disabled (or set in a high-Z state)— e.g., no pulses are received by first switching transistor 312 and second switching transistor 314. As described above, in some embodiments, reference voltage 321 (e.g., about 1.2 to about 1.25 V) can be higher than regulated voltage 415 (e.g., about 1.0 to about 1.15 V) but lower than a maximum ripple voltage 612 (e.g., about 1.3 to about 1.5 V) when voltage regulator 210 is enabled.

Referring to waveform 620, during time period time to t₀ time t₄, predetermined period of time 625 is at logic high (e.g., ON). During this time period, frequency detection circuit 526 monitors a number of times the output of logic OR circuit 522 transitions from logic low to logic high (and/or vice versa)—which is indicative of a number of pulses received by first switching transistor 312 and second switching transistor 314 and a number of charge cycles generated by voltage regulator 210 during the time period. In some embodiments, predetermined period of time 625 can start (e.g., transition from logic low to logic high) at the beginning of a charge cycle of voltage regulator 210 (e.g., at time t₀).

Referring to waveform 630, during time period time to t₀ time t₃, voltage regulator disable signal 215 is at logic high (e.g., ON). In some embodiments, the time period in which voltage regulator disable signal 215 is at logic high is based on a predetermined charge cycle time (e.g., time period time to t₀ time t₂) plus an extended adjustable delay 635. Adjustable delay 635 is provided by adjustable delay circuit 528. As described above, the predetermined charge cycle time is associated with a time period that ensures a full transfer of charge (e.g., time period time to t₀ time t₁) from voltage regulator 210 to load circuit 230. In some embodiments, the predetermined charge cycle time can be extended based on adjustable delay 635. For a higher activation frequency of voltage regulator 210 (e.g., voltage regulator 210 generates a higher number of charge cycles over predetermined period of time 625), adjustable delay 635 can be shorter compared to an adjustable delay associated with a lower activation frequency of voltage regulator 210 (e.g., voltage regulator 210 generates a lower number of charge cycles over predetermined period of time 625). Conversely, for a lower activation frequency, adjustable delay 635 can be longer compared to an adjustable delay associated with a higher activation frequency of voltage regulator 210.

During time period time is to time t₉, waveforms 610, 620, and 630 behave in a similar manner as their respective waveforms during time period time to t₀ time t₄. A benefit of extending the predetermined charge cycle time by adjustable delay 635, among others, is that an extended amount of time is provided to supply voltage 115 to settle—thus decreasing the likelihood of a pulse grouping scenario. Further, a benefit of implementing adjustable delay 635, among others, is the flexibility in providing a variable amount of time for supply voltage 115 to settle based on an activation frequency of voltage regulator 210. Without adjustable delay 635, inadvertent charge cycles can be generated by voltage regulator 210—e.g., pulse grouping— thus increasing the likelihood of non-compliance with voltage ripple specifications, worsening load versus frequency monotonicity, and generating an undesirable audible noise.

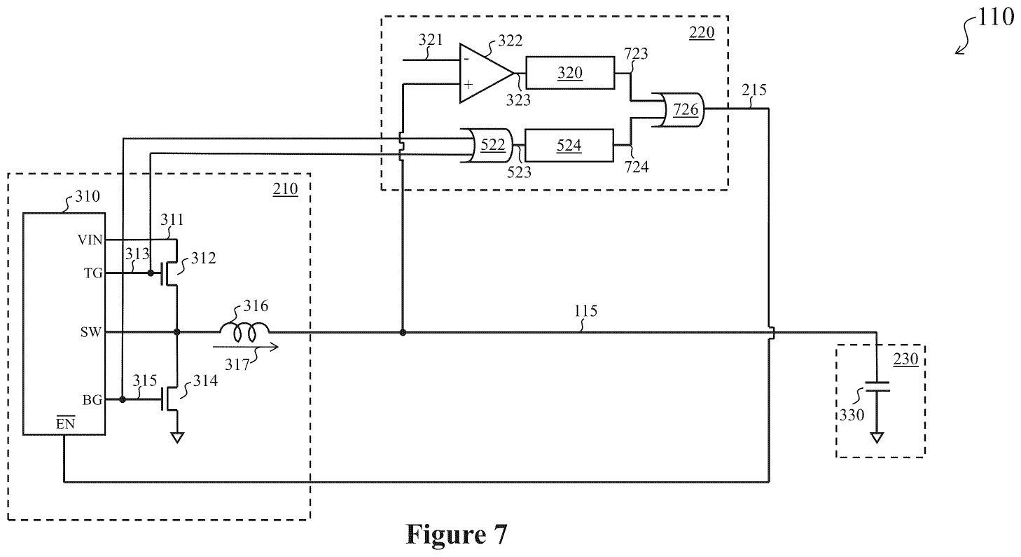

FIG. 7 is an illustration of yet another circuit-level representation of power management circuit 110, according to some embodiments. This circuit-level representation includes voltage regulator 210, yet another embodiment of pulse grouping control circuit 220, and load circuit 230. The descriptions of voltage regulator 210 and load circuit 230 are similar to the descriptions above.

Pulse grouping control circuit 220 includes voltage regulator control circuit 320, comparator circuit 322, logic OR circuit 522, voltage regulator control circuit 524, and a logic OR circuit 726. The descriptions of voltage regulator control circuit 320, comparator circuit 322, logic OR circuit 522, and voltage regulator control circuit 524 are similar to the descriptions above. With regard to logic OR circuit 726, if either of its inputs—which corresponds to an input signal 723 (output of voltage regulator control circuit 320) and to an input signal 724 (output of voltage regulator control circuit 524)—is at logic high (e.g., ON), then an output of logic OR circuit 726 (voltage regulator disable signal 215) is at logic high, thus disabling voltage regulator 210.

As described above, if comparator circuit output 323 is at logic high, voltage regulator control circuit 320 is configured to disable voltage regulator 210 after a charge cycle of voltage regulator 210 and for a period of time until the voltage at the output node of voltage regulator 210 is below reference voltage 321 (e.g., for a period of time until comparator circuit output 323 transitions from logic high to logic low). Also, voltage regulator control circuit 524 is configured to monitor a charge cycle of voltage regulator 210 for a predetermined charge cycle time that can be extended by adjustable delay circuit 528 (not shown in FIG. 7) and to prevent voltage regulator 210 from generating another charge cycle during the predetermined charge cycle time (and the extended delay time, if any). Voltage regulator control circuit 320 and voltage regulator control circuit 524 can be used in combination to mitigate pulse grouping by voltage regulator 210.

For example, if an output node of voltage regulator 210 discharges below the regulated voltage of voltage regulator 210, voltage regulator 210 generates a charge cycle (e.g., via switch controller 310 to send pulses to first switching transistor 312 and second switching transistor 314) during a predetermined charge cycle time. The predetermined charge cycle time can be extended by an adjustable delay-based on the activation frequency of voltage regulator 210—to allow additional time for the output node to settle. Voltage regulator control circuit 524 can extend the predetermined charge cycle time by adding an adjustable delay-based on the activation frequency of voltage regulator 210—to allow additional time for the output node to settle. During the predetermined charge cycle time and the extended adjustable delay, voltage regulator control circuit 524 prevents voltage regulator 210—via voltage regulator disable signal 215—from generating another charge cycle.

After the predetermined charge cycle time and adjustable delay has passed, if voltage regulator 210 generates an inadvertent charge cycle due to an undesirable pulse grouping scenario (e.g., due to the parasitic effects of load circuit 230, internal noise in electronic system 100, a comparator offset variation in voltage regulator 210, and combinations thereof), voltage regulator control circuit 320 disables voltage regulator 210 for a period of time until the voltage at the output node is below reference voltage 321. In some embodiments, this period of time can be longer than the predetermined charge cycle time with an adjustable delay. To disable voltage regulator 210, voltage regulator control circuit 320 can disable switch controller 310—via voltage regulator disable signal 215—by preventing pulses to be received by first switching transistor 312 and second switching transistor 314, according to some embodiments.

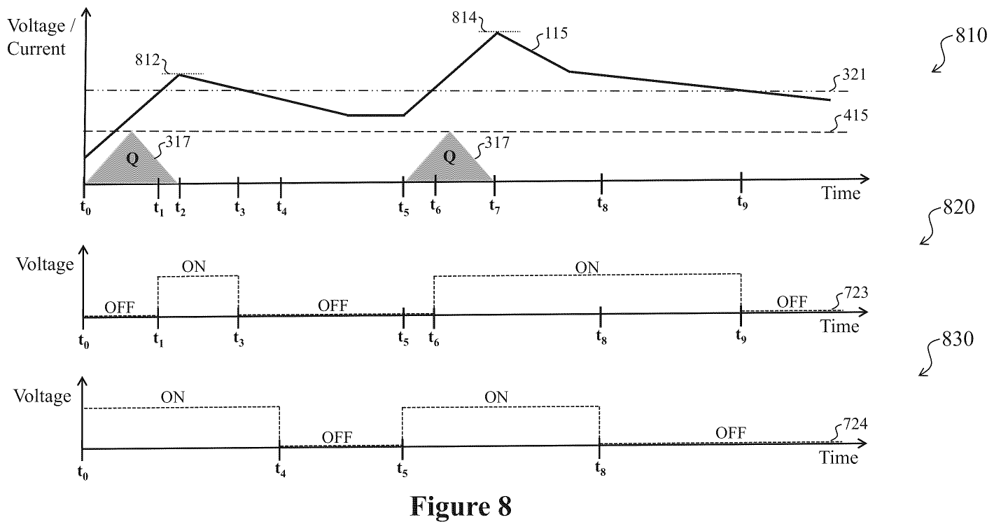

FIG. 8 is an illustration of waveforms 810, 820, and 830 showing an operation of the power management circuit of FIG. 7, according to some embodiments. Waveform 810 shows an example behavior of supply voltage 115 over time and an example behavior of current 317 (e.g., current flowing through inductor 316 of voltage regulator 210) over time. Waveform 820 shows an example behavior of an output of voltage regulator control circuit 320 (i.e., input signal 723 to logic OR circuit 726) over time. Waveform 830 shows an example behavior of an output of voltage regulator control circuit 524 (i.e., input signal 724 to logic OR circuit 726). The curvatures in waveforms 810, 820, and 830 are exemplary and for illustration purposes; these waveforms may include different curvatures.

Referring to waveform 810, during time period time to t₀ time t₄, supply voltage 115 falls below regulated voltage 415 of voltage regulator 210—e.g., due to a current drawn by load circuit 230. Because supply voltage 115 is below regulated voltage 415, voltage regulator 210 is enabled, causing switch controller 310 to adjust the switching frequency of first switching transistor 312 and second switching transistor 314 to raise supply voltage 115. During time period time to t₀ time t₂, voltage regulator 210 fully transfers current 317 (or charge Q) to load circuit 230, thus raising supply voltage 115 above regulated voltage 415. Once supply voltage 115 reaches regulated voltage 415, voltage regulator 210 is disabled (or set in a high-Z state)— e.g., no pulses are received by first switching transistor 312 and second switching transistor 314. As described above, in some embodiments, reference voltage 321 (e.g., about 1.2 to about 1.25 V) can be higher than regulated voltage 415 (e.g., about 1.0 to about 1.15 V) but lower than a maximum ripple voltage 812 (e.g., about 1.3 to about 1.5 V) when voltage regulator 210 is enabled.

Referring to waveform 820, during time period time t₁ to time t₃, the output of voltage regulator control circuit 320 (i.e., input signal 723) is at logic high (e.g., ON). During time period time t₁ to time t₃, supply voltage 115 is above reference voltage 321. While the output of voltage regulator control circuit 320 (i.e., input signal 723) is at logic high, voltage regulator control circuit 320 is configured to disable voltage regulator 210—via voltage regulator disable signal 215—by preventing pulses to be received by first switching transistor 312 and second switching transistor 314, according to some embodiments.

Referring to waveform 830, during time period time to t₀ time t₄, the output of voltage regulator control circuit 524 (i.e., input signal 724) is at logic high (e.g., ON). In some embodiments, the time period in which the output of voltage regulator control circuit 524 (i.e., input signal 724) is at logic high is based on a predetermined charge cycle time plus an extended adjustable delay (e.g., adjustable delay 635 of FIG. 6). The adjustable delay can be provided by adjustable delay circuit 528 (not shown in FIG. 7). As described above, the predetermined charge cycle time is associated with a time period that ensures a full transfer of charge (e.g., time period time to t₀ time t₂) from voltage regulator 210 to load circuit 230. In some embodiments, the predetermined charge cycle time can be extended based on the adjustable delay. For a higher activation frequency of voltage regulator 210 (e.g., voltage regulator 210 generates a higher number of charge cycles over a predetermined period of time), the adjustable delay can be shorter compared to an adjustable delay associated with a lower activation frequency of voltage regulator 210 (e.g., voltage regulator 210 generates a lower number of charge cycles over the predetermined period of time). Conversely, for a lower activation frequency, the adjustable delay can be longer compared to an adjustable delay associated with a higher activation frequency of voltage regulator 210.

Referring to waveform 810, at time t₄, voltage regulator 210 has completed a charge cycle, supply voltage 115 is below reference voltage 321, and predetermined charge cycle time 425 and voltage regulator disable signal 215 are at logic low (e.g., OFF). During time period time t₄ to time t₅, while supply voltage 115 is between regulated voltage 415 and reference voltage 321, an undesirable pulse grouping scenario can occur (e.g., due to the parasitic effects of load circuit 230, internal noise in electronic system 100, a comparator offset variation in voltage regulator 210, and combinations thereof) and cause voltage generator 210 to generate an inadvertent charge cycle during time period time is to time t₇. Due to the inadvertent charge cycle, supply voltage 115 rises to a maximum ripple voltage 814 higher than maximum ripple voltage 812.

Referring to waveform 820, during time period time t₆ to time t₉, the output of voltage regulator control circuit 320 (i.e., input signal 723) is at logic high (e.g., ON) while supply voltage 115 is above reference voltage 321—thus disabling voltage regulator 210. Compared to the output of voltage regulator control circuit 320 (i.e., input signal 723) during time period time t₁ to time t₃, the output of voltage regulator control circuit 320 (i.e., input signal 723) during time period time t₆ to time t₉ can be at logic high for a longer amount of time because of the discharge time of supply voltage 115. As described above, due to the inadvertent charge cycle, maximum ripple voltage 814 can be higher than maximum ripple voltage 812. In turn, the higher maximum ripple voltage 814 can result in a longer time for supply voltage 115 to discharge to reference voltage 321 as compared to maximum ripple voltage 812.

Referring to waveform 830, during time period time is to time t₈, the output of voltage regulator control circuit 524 (i.e., input signal 724) behaves in a similar manner as time period time to t₀ time t₄. In some embodiments, the output of voltage regulator control circuit 524 (i.e., input signal 724) can be at logic high for a shorter amount of time than the output of voltage regulator control circuit 320 (i.e., input signal 723). Since input signals 723 and 724 are received by logic OR circuit 726, the output of logic OR circuit (voltage regulator disable signal 215) is at logic high when either input signal 723 or input signal 724 is at logic high. Thus, in the pulse grouping scenario, voltage regulator disable signal 215 can be at logic high—thus disabling voltage regulator 210—longer than predetermined charge cycle time with extended adjustable delay. A benefit of extending the time that voltage regulator 210 is disabled, among others, is that an extended amount of time is provided to supply voltage 115 to settle—thus decreasing the likelihood of a pulse grouping scenario. Without the varying the time period of voltage regulator disable signal 215—based on the outputs of voltage regulator control circuit 320 and voltage regulator control circuit 524—an increased number of inadvertent charge cycles can be generated by voltage regulator 210, thus increasing the likelihood of non-compliance with voltage ripple specifications, worsening load versus frequency monotonicity, and generating an undesirable audible noise.

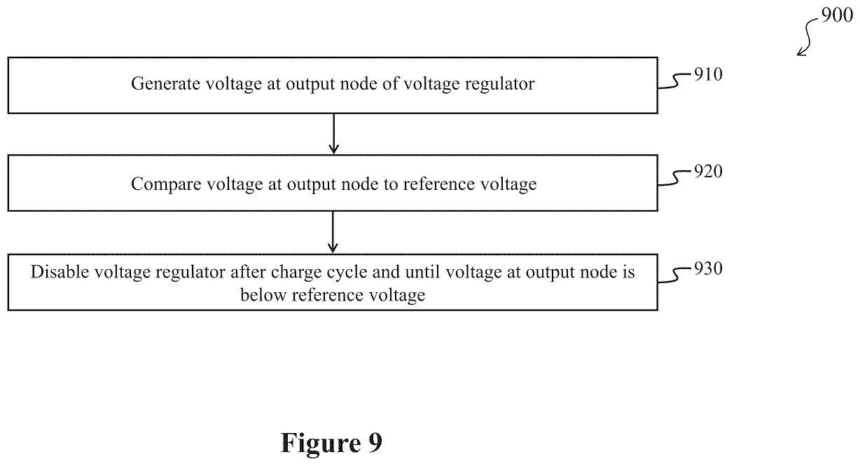

FIG. 9 is an illustration of a method 900 for mitigating pulse grouping in a voltage regulator, according to some embodiments. For illustrative purposes, the operations illustrated in method 900 will be described with reference to the circuit-level representation of power management circuit 110 shown in FIG. 3. Other representations of power management circuit 110 are within the scope of the present disclosure. Also, additional operations may be performed between various operations of method 900 and may be omitted merely for clarity and ease of description. The additional operations can be provided before, during, and/or after method 900, in which one or more of these additional operations are briefly described herein. Moreover, not all operations may be needed to perform the disclosure provided herein. Additionally, some of the operations may be performed simultaneously or in a different order than shown in FIG. 9. In some embodiments, one or more other operations may be performed in addition to or in place of the presently-described operations.

At operation 910 of FIG. 9, a voltage is generated at an output node of a voltage regulator. Referring to FIG. 3, voltage regulator 210 generates supply voltage 115 at an output node.

At operation 920 of FIG. 9, the voltage at the output node is compared to a reference voltage that is lower than a maximum ripple voltage of the voltage regulator. Referring to FIG. 3, comparator circuit 322 compares the voltage at the output node of voltage regulator 210 (e.g., supply voltage 115) to reference voltage 321. If the voltage at the output node of voltage regulator 210 is below reference voltage 321, a comparator circuit output 323 is at logic low. Conversely, if the voltage at the output node of voltage regulator 210 is above reference voltage 321, comparator circuit output 323 is at logic high.

At operation 930 of FIG. 9, the voltage regulator is disabled after the voltage regulator has generated a charge cycle and for a period of time until the voltage at the output node is below the reference voltage. Referring to FIG. 3, in some embodiments, voltage regulator control circuit 320 is configured to monitor the charge cycle of voltage regulator 210 for a predetermined charge cycle time and to prevent voltage regulator 210 from generating another charge cycle during the predetermined charge cycle time. To prevent voltage regulator 210 from generating another charge cycle, voltage regulator control circuit 320 can disable switch controller 310—via voltage regulator disable signal 215—by preventing pulses to be received by first switching transistor 312 and second switching transistor 314, according to some embodiments.

After the predetermined charge cycle time, if the voltage at the output node of voltage regulator 210 is above reference voltage 321, voltage regulator control circuit 320 is configured to delay the enablement of voltage regulator 210 until the voltage at the output node is below reference voltage 321. In some embodiments, the predetermined charge cycle time can be based on a time period associated with a full transfer of charge from voltage regulator 210 to load circuit 230. The predetermined charge cycle time can be longer than the time period associated with the full transfer of charge to ensure that the charge transfer operation is completed, according to some embodiments.

In some embodiments, the time period of voltage regulator disable signal 215 can vary based on the voltage level of supply voltage 115. For example, referring to waveform 430 in FIG. 4, the time period of voltage regulator disable signal 215 can vary based on a maximum ripple voltage of voltage regulator 210. Due to the inadvertent charge cycle, maximum ripple voltage 414 can be higher than maximum ripple voltage 412. In turn, the higher maximum ripple voltage 414 can result in a longer time for supply voltage 115 to discharge to reference voltage 321 as compared to maximum ripple voltage 412—thus resulting in a longer time period that voltage regulator disable signal 215 is at logic high.

A benefit of the varying time period of voltage regulator disable signal 215, among others, is that an extended amount of time is provided to supply voltage 115 to settle—thus decreasing the likelihood of a pulse grouping scenario. Without the varying time period of voltage regulator disable signal 215, an increased number of inadvertent charge cycles can be generated by voltage regulator 210—e.g., pulse grouping—thus increasing the likelihood of non-compliance with voltage ripple specifications, worsening load versus frequency monotonicity, and generating an undesirable audible noise.

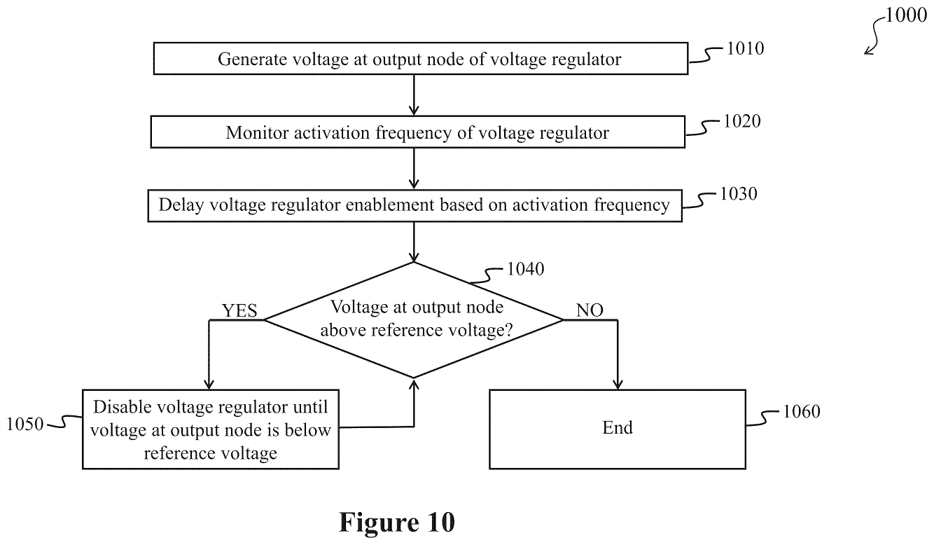

FIG. 10 is an illustration of another method 1000 for mitigating pulse grouping in a voltage regulator, according to some embodiments. For illustrative purposes, the operations illustrated in method 1000 will be described with reference to the circuit-level representation of power management circuit 110 shown in FIGS. 5 and 7. Other representations of power management circuit 110 are within the scope of the present disclosure. Also, additional operations may be performed between various operations of method 1000 and may be omitted merely for clarity and ease of description. The additional operations can be provided before, during, and/or after method 1000, in which one or more of these additional operations are briefly described herein. Moreover, not all operations may be needed to perform the disclosure provided herein. Additionally, some of the operations may be performed simultaneously or in a different order than shown in FIG. 10. In some embodiments, one or more other operations may be performed in addition to or in place of the presently-described operations.

At operation 1010 of FIG. 10, a voltage is generated at an output node of a voltage regulator. Referring to FIGS. 5 and 7, voltage regulator 210 generates supply voltage 115 at an output node.

At operation 1020 of FIG. 10, an activation frequency of the voltage regulator is monitored. Referring to FIGS. 5 and 7, frequency detection circuit 526 can monitor a number of times the output of logic OR circuit 522 transitions from logic low to logic high (and/or vice versa)—which is indicative of a number pulses received by first switching transistor 312 and second switching transistor 314 and a number of charge cycles generated by voltage regulator 210 over the predetermined period of time. Other methods can be used to measure the activation frequency of voltage regulator 210.

At operation 1030 of FIG. 10, enablement of the voltage regulator is delayed for a time period based on the activation frequency. Referring to FIGS. 5 and 7, adjustable delay circuit 528 can extend a predetermined charge cycle time of voltage regulator 210—thus delaying the enablement of voltage regulator 210—based on an activation frequency of voltage regulator 210 measured by frequency detection circuit 526. Based on the activation frequency measured by frequency detection circuit 526, adjustable delay circuit 528 can select a delay element associated with the measured activation frequency. In some embodiments, adjustable delay circuit 528 generates the time period that delays enablement of voltage regulator 210 by adding the delay associated with the delay element to the predetermined charge cycle time.

At operation 1040 of FIG. 10, a determination is made on whether the voltage at the output node of the voltage regulator is above a reference voltage. Referring to FIG. 7, comparator circuit 322 compares the voltage at the output node of voltage regulator 210 (e.g., supply voltage 115) to reference voltage 321. If the voltage at the output node of voltage regulator 210 is below reference voltage 321, comparator circuit output 323 is at logic low. Conversely, if the voltage at the output node of voltage regulator 210 is above reference voltage 321, comparator circuit output 323 is at logic high.

At operation 1050 of FIG. 10, if the voltage at the output node is higher than the reference voltage, the voltage regulator is disabled until the voltage at the output node is below the reference voltage. Referring to FIG. 7, if comparator circuit output 323 is at logic high, voltage regulator control circuit 320 is configured to disable voltage regulator 210—via voltage regulator disable signal 215—after a charge cycle of voltage regulator 210 and for a period of time until the voltage at the output node of voltage regulator 210 is below reference voltage 321 (e.g., for a period of time until comparator circuit output 323 transitions from logic high to logic low), according to some embodiments.

At operation 1060 of FIG. 10, if the voltage at the output node is not higher than the reference voltage, method 1000 ends.

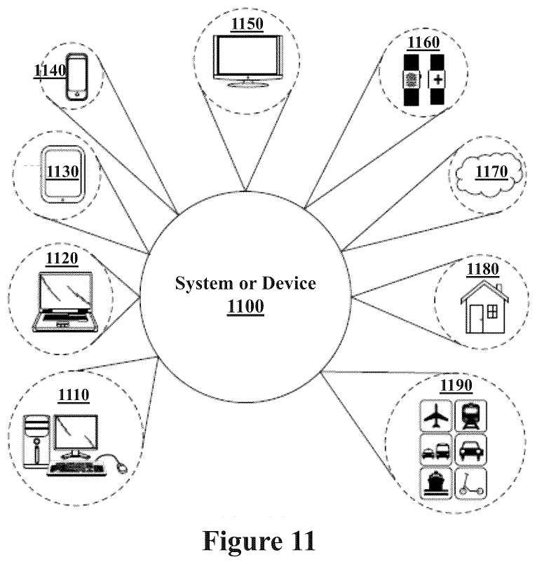

FIG. 11 is an illustration of exemplary systems or devices that can include the disclosed embodiments. System or device 1100 can incorporate one or more of the disclosed embodiments in a wide range of areas. For example, system or device 1100 can be implemented in one or more of a desktop computer 1110, a laptop computer 1120, a tablet computer 1130, a cellular or mobile phone 1140, and a television 1150 (or a set-top box in communication with a television).

Also, system or device 1100 can be implemented in a wearable device 1160, such as a smartwatch or a health-monitoring device. In some embodiments, the smartwatch can have different functions, such as access to email, cellular service, and calendar functions. Wearable device 1160 can also perform health-monitoring functions, such as monitoring a user's vital signs and performing epidemiological functions (e.g., contact tracing and providing communication to an emergency medical service). Wearable device 1160 can be worn on a user's neck, implantable in user's body, glasses or a helmet designed to provide computer-generated reality experiences (e.g., augmented and/or virtual reality), any other suitable wearable device, and combinations thereof.

Further, system or device 1100 can be implemented in a server computer system, such as a dedicated server or on shared hardware that implements a cloud-based service 1170. System or device 1100 can be implemented in other electronic devices, such as a home electronic device 1180 that includes a refrigerator, a thermostat, a security camera, and other suitable home electronic devices. The interconnection of such devices can be referred to as the “Internet of Things” (IoT). System or device 1100 can also be implemented in various modes of transportation 1190, such as part of a vehicle's control system, guidance system, and/or entertainment system.

The systems and devices illustrated in FIG. 11 are merely examples and are not intended to limit future applications of the disclosed embodiments. Other example systems and devices that can implement the disclosed embodiments include portable gaming devices, music players, data storage devices, and unmanned aerial vehicles.

It is to be appreciated that the Detailed Description section, and not the Abstract of the Disclosure section, is intended to be used to interpret the claims. The Abstract of the Disclosure section may set forth one or more but not all possible embodiments of the present disclosure as contemplated by the inventor(s), and thus, are not intended to limit the subjoined claims in any way.

Unless stated otherwise, the specific embodiments are not intended to limit the scope of claims that are drafted based on this disclosure to the disclosed forms, even where only a single example is described with respect to a particular feature. The disclosed embodiments are thus intended to be illustrative rather than restrictive, absent any statements to the contrary. The application is intended to cover such alternatives, modifications, and equivalents that would be apparent to a person skilled in the art having the benefit of this disclosure.

The foregoing disclosure outlines features of several embodiments so that those skilled in the art may better understand the aspects of the present disclosure. Those skilled in the art will appreciate that they may readily use the present disclosure as a basis for designing or modifying other processes and structures for carrying out the same purposes and/or achieving the same advantages of the embodiments introduced herein. Those skilled in the art will also realize that such equivalent constructions do not depart from the spirit and scope of the present disclosure, and that they may make various changes, substitutions, and alterations herein without departing from the spirit and scope of the present disclosure.

1. A system, comprising:
a voltage regulator comprising an output node and configured to generate a voltage at the output node;
a comparator circuit configured to compare the voltage at the output node to a reference voltage; and
a control circuit configured to, in response to an errant charge cycle being generated by the voltage regulator,
disable the voltage regulator until the voltage at the output node is below the reference voltage.

2. The system of claim 1, wherein the control circuit is further configured to disable the voltage regulator in response to the voltage regulator having generated a charge cycle and for a period of time until the voltage at the output node is below the reference voltage.

3. The system of claim 2, wherein the voltage regulator comprises a step-up voltage converter, a step-down voltage converter, or a step up/down voltage converter.

4. The system of claim 1, wherein the reference voltage is lower than a maximum ripple voltage of the voltage regulator.

5. The system of claim 1, wherein the control circuit is further configured to prevent the voltage regulator from generating a charge cycle during a predetermined charge cycle time associated with the charge cycle.

6. The system of claim 5, wherein the predetermined charge cycle time is longer than a time associated with a transfer of charge from the voltage regulator to a load circuit electrically connected to the voltage regulator.

7. The system of claim 6, wherein the period of time until the voltage at the output node is below the reference voltage is longer than the predetermined charge cycle time.

8. The system of claim 1, wherein, to disable the voltage regulator, the control circuit is further configured to prevent pulses from being received by one or more switching transistors in the voltage regulator.

9. A system, comprising:
a voltage regulator comprising an output node and configured to transfer charge to the output node over a period of time equal to a summation of a predetermined charge cycle time and a delay;
a frequency detection circuit configured to monitor an activation frequency of the voltage regulator to transfer charge to the output node; and
an adjustable delay circuit configured to decrease the delay, in response to an increase in the activation frequency.

10. The system of claim 9, wherein the frequency detection circuit is further configured to monitor a number of charge pulses generated by the voltage regulator over a predetermined period of time.

11. The system of claim 9, wherein the adjustable delay circuit comprises a plurality of delay elements associated with a respective plurality of activation frequency ranges of the voltage regulator.

12. (canceled)

13. The system of claim 9, wherein the adjustable delay circuit is configured to increase the delay, in response to a decrease in the activation frequency.

14. The system of claim 9, wherein the predetermined charge cycle time is associated with a transfer of charge from the voltage regulator to a load circuit electrically connected to the voltage regulator.

15. The system of claim 9, further comprising:
a comparator circuit configured to compare a voltage at the output node to a reference voltage; and
a control circuit configured to, after the period of time has passed, disable the voltage regulator for an other period of time until the voltage at the output node is below the reference voltage.

16. The system of claim 15, wherein the other period of time is longer than the period of time.

17. A method, comprising:
generating a voltage at an output node of a voltage regulator;
comparing the voltage at the output node to a reference voltage, wherein the reference voltage is lower than a maximum ripple voltage of the voltage regulator; and
disabling the voltage regulator until the voltage at the output node is below the reference voltage, in response to an errant charge cycle being generated by the voltage regulator.

18. The method of claim 17, further comprising disabling the voltage regulator during a period of time associated with the transfer of charge from the voltage regulator to the load circuit.

19. The method of claim 17, wherein disabling the voltage regulator comprises disabling a switch controller in the voltage regulator.

20. The method of claim 17, wherein disabling the voltage regulator comprises disabling the voltage regulator for a period of time that varies based on a maximum ripple voltage of the voltage regulator.

21. The method of claim 17, wherein disabling the voltage regulator comprises disabling the voltage regulator to prevent the voltage regulator from generating a charge cycle during a predetermined charge cycle time associated with the charge cycle.
